(19) United States
(12) Patent Application Publication
(10) Pub. No.: US 2023/0132742 A1
(43) Pub. Date: May 4, 2023

(54) End-to-End Encrypted Location-Finding

(71) Applicant: Google LLC, Mountain View, CA (US)

(72) Inventors: Marcel M.M. Yung, New York, NY (US); David Lazarov, Petah Tikva (IL)

(73) Assignee: Google LLC, Mountain View, CA (US)

(21) Appl. No.: 17/907,087

(22) PCT Filed: Apr. 5, 2021
(86) PCT No.: PCT/US2021/025743

§ 371 Date: Sep. 22, 2022

Related U.S. Application Data
(60) Provisional application No. 63/010,370, filed on Apr. 15, 2020.

(51) Int. Cl. H04L 9/40; H04L 9/08; H04L 9/30; H04L 9/06

(52) U.S. Cl. CPC H04L 63/0485; H04L 9/0869; H04L 9/30; H04L 9/0631

(57) ABSTRACT

This document describes methods, devices, systems, and means to ensure end-to-end encryption of location information that is forwarded through a potentially untrustworthy cloud service that serves to forward the location information from a sighting device to an owner of a sighted device. The end-to-end encryption of location information preserves the privacy of location information that is provided by sighter devices that are not associated with the owner as the location information traverses network nodes from the sighter to the owner.

### BACKGROUND

Beacon systems using ephemeral identifiers are designed to give developers control over which clients can make use of their beacon signals. Ephemeral identifiers and keys shared between a beacon and the beacon's owner enable resolver services to determine the owner of a beacon when a sighter sends the ephemeral identifier to the resolver service. The communication between the sighter of the beacon and the resolver as well as the communication between the resolver and the owner are secured; however, any communication between the beacon and/or the sighter and the owner is not secure and is visible to the resolver.

### SUMMARY

This summary is provided to introduce simplified concepts of end-to-end encrypted location-finding. The simplified concepts are further described below in the Detailed Description. This summary is not intended to identify essential features of the claimed subject matter, nor is it intended for use in determining the scope of the claimed subject matter.

In aspects, methods, devices, systems, and means for end-to-end encrypted location-finding in a wireless network are described in which a sighter receives, from a beacon, a packet including an end-to-end encrypted ephemeral identifier (E2EE-EID). The sighter generates a public key using the received E2EE-EID and a seed value. The sighter concatenates an 80 least significant bits of the E2EE-EID and an 80 least significant bits of the seed value to generate a nonce. The sighter encrypts a message for the owner using the generated public key and the nonce, and the sighter transmits the encrypted message to the owner.

In aspects, methods, devices, systems, and means for end-to-end encrypted location-finding in a wireless network are described in which a beacon determines an identity key that is shared between the beacon and an owner. The beacon generates an end-to-end encrypted ephemeral identifier (E2EE-EID) using the identity key and a time value. The beacon generates a beacon packet including the E2EE-EID and transmits the beacon packet, the transmitted beacon packet being usable by a sighter receiving the beacon packet to transmit a secure message to the owner.

In aspects, methods, devices, systems, and means for end-to-end encrypted location-finding in a wireless network are described in which an owner retrieves a message from a resolver, the message including an end-to-end encrypted ephemeral identifier (E2EE-EID). The owner generates a public key using the received E2EE-EID and a seed value. The owner concatenates an 80 least significant bits of the E2EE-EID and an 80 least significant bits of the seed value to generate a nonce, and the owner decrypts the received message using the generated public key and the nonce.

While features and concepts of the described systems and methods for end-to-end encrypted location-finding can be implemented in any number of different environments, systems, devices, and/or various configurations, embodiments of end-to-end encrypted location-finding are described in the context of the following example devices, systems, and configurations.

### BRIEF DESCRIPTION OF THE DRAWINGS

Embodiments of end-to-end encrypted location-finding are described with reference to the following drawings. The same numbers are used throughout the drawings to reference like features and components:

FIG. 1 illustrates an example environment in which various embodiments of end-to-end encrypted location-finding can be implemented.

FIG. 2 illustrates example data and control transactions between devices in accordance with aspects of end-to-end encrypted location-finding.

FIG. 3 illustrates an example method of end-to-end encrypted location-finding in accordance with embodiments of the techniques described herein.

FIG. 4 illustrates an example method of end-to-end encrypted location-finding in accordance with embodiments of the techniques described herein.

FIG. 5 illustrates an example method of end-to-end encrypted location-finding in accordance with embodiments of the techniques described herein.

FIG. 6 illustrates an example network device that can be implemented in a network environment in accordance with one or more embodiments of the techniques described herein.

FIG. 7 illustrates an example beacon device that can be implemented in a network environment in accordance with one or more embodiments of the techniques described herein.

### DETAILED DESCRIPTION

This document describes methods, devices, systems, and means to ensure end-to-end encryption of location information that is forwarded through a potentially untrustworthy cloud service that serves to forward the location information from a sighting device to an owner of a sighted device. The end-to-end encryption of location information preserves the privacy of location information that is provided by sighter devices that are not associated with the owner as the location information traverses network nodes from the sighter to the owner.

Many electronic devices advertise short-range wireless signals while they operate, devices such as earbuds, smart watches, smartphones, cameras, tracking tags, or the like. Using suitable wireless technologies and protocols, the advertised wireless signals enable receivers, such as smartphones, network-connected speakers, home automation hubs, security hubs, or the like, to identify these electronic devices. If a receiver is aware of its location (e.g., geographic location) the receiver can upload a location at which an advertised signal was received from an electronic device together with an identity of the electronic device. For example, the receiver can upload the location at which the electronic device was sighted to a service (e.g., a cloud-based service) to allow an owner of the electronic device to query for the location of the electronic device in the event the owner misplaces the electronic device.

However, the privacy of the reported location information of the electronic device and the device's identity must be considered, in order to protect against bad actors potentially obtaining and exploiting this information. Having the electronic device broadcast an unchanging identifier in an advertisement transmission could enable anyone to track the electronic device, including potentially using the information to track a person (such as the person who owns the electronic device) carrying the electronic device or any object to which the electronic device may be affixed.

Protocols like Eddystone-EID and FastPair introduced techniques to protect the privacy of the identity of the electronic device by having the electronic device advertise a message that included a rotating identifier based on a predetermined mechanism to allow the owner (and only the owner) to identify the electronic device. However, additional protections can be added to these approaches to keep the reported location of the electronic device private to all but the owner.

For example, low-power wireless beacons, such as Bluetooth Low Energy (Bluetooth LE, BLE) beacons, transmit information in a beacon packet (e.g., an advertising channel protocol data unit (PDU)). A beacon may transmit broadcast information that is directly identifiable, such as unencrypted data, or broadcast an identifier that changes every few minutes, such as an ephemeral identifier (ephemeral ID, EID). The ephemeral identifier can be resolved to useful information by an owner that shares an identity key (the Ephemeral Identity Key, or EIK) with the individual beacon. Although the following discussion frequently refers to BLE, BLE is an example wireless technology that is discussed for simplicity, but the ephemeral identifiers discussed herein may also be applied to another wireless technology (e.g., Ultra Wideband (UWB), Wireless Local Area Network (WLAN), Near Field Communication (NFC), a personal area network (PAN), IEEE 802.15.4, ZigBee, Thread, or the like) in a similar manner.

### Example Environment

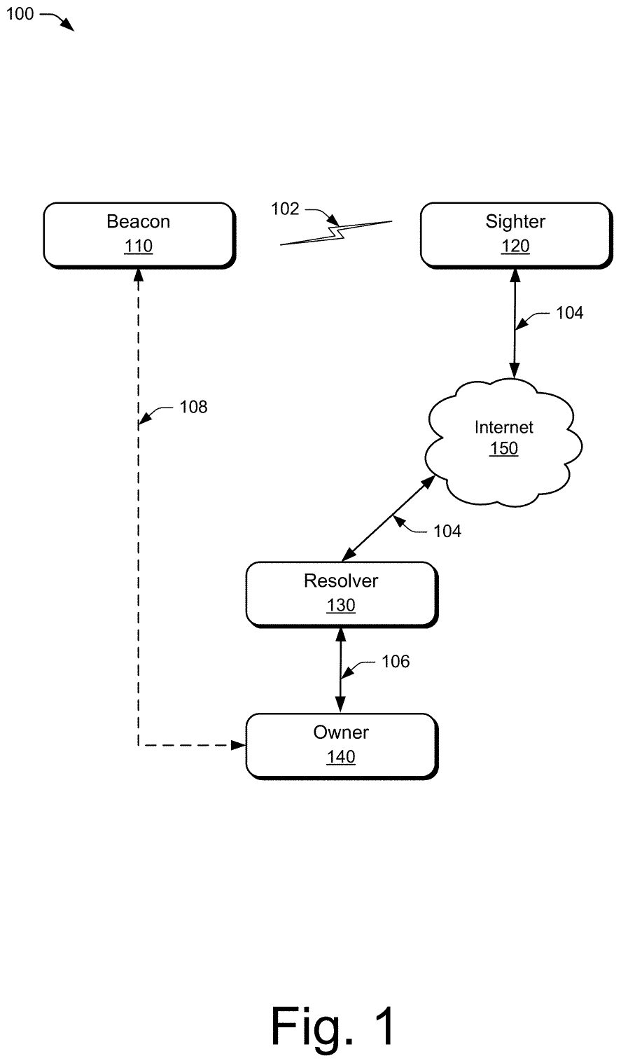

FIG. 1 illustrates an example environment 100 in which various embodiments of end-to-end encrypted location-finding can be implemented. The environment 100 includes a beacon 110, a sighter 120, a resolver 130, and an owner 140. The beacon 110 is a device, such as a BLE beacon, a headset, or the like that periodically broadcasts (e.g., transmits) beacon packets, as shown at 102. The sighter (or observer) 120 is a device, such as a smartphone, that can receive the beacon packets and forward the received packets to a resolver service, as shown at 104. For example, the sighter 120 forwards the received packets to a resolver service 130 via the Internet 150. In this example, the Internet 150 represents any combination of wired and/or wireless, local and/or wide area networks that interconnect the sighter 120, the resolver 130, and/or the owner 140. The resolver 130, such as a cloud-based resolver service (resolution service) compares received EIDs against hash values of shared keys and associated owners to determine the correct owner and forward the received packet to the correct owner 140, as shown at 106. Alternatively or additionally, the owner 140 can query the resolver 130 for packets or messages received from sighters 120 for any beacons 110 associated with the owner 140. The owner 140 is a device or service, such as a smartphone, computer, or cloud-based service, associated with the beacon 110. The owner 140 may own one or more beacons 110 and store the shared keys for each of those beacons 110.

End-to-end encrypted location-finding can be used with any suitable devices configured for communication as illustrated in FIG. 1. The owner 140 can be any owner computing system. The beacon 110 can be any device associated with the owner computing system. A communication from the device to the owner computing system is anonymized (by hiding the identities of both the device and owner computing system) and involving a routing system (e.g., the resolver 130) to resolve the anonymity into an identification of the owner computing system and device and connecting the device to the owner computing system. The sighter 120 can be any sighter system that is an intermediary device that receives a beacon packet from the device and sends sighting information about the sighting of the device to its owner computing system in spite of the anonymity. The sighting information is kept secure from the resolver (and any other network nodes) except the owner computing system.

The beacon 110 is a device that periodically transmits (broadcasts) a beacon packet (e.g., a BLE advertisement packet) that includes an ephemeral identifier (EID) that is generated from a shared key (EIK), which is shared between the beacon 110 and the owner 140, and the time at which the EID is generated by the beacon 110. The beacon 110 calculates a new EID at a rotation rate known to the beacon 110 and its owner 140. The beacon 110 may have limited computational and power resources and broadcasts the beacon packets over a limited range. The sighter 120 can receive beacon packets from the beacon 110 and has access to a longer-range network (e.g., a Wide Area Network, WAN). The sighter 120 can connect to cloud-based services, such as the resolver 130, over the longer-range network. This enables the sighter 120 to forward received beacon packets to a cloud-based resolver 130. The resolver 130 can be a device (server) or a collection of devices that form a cloud-based service. The resolver 130 stores a set of owners 140 and associated EIDs for those owners. The resolver 130 compares a received EID from a beacon packet to its stored set of EIDs to determine the associated owner 140 for the received beacon packet. Once an owner 140 is identified for a received beacon packet, the resolver 130 can forward the beacon packet to the correct owner 140 of that packet.

At initialization of a beacon 110, the beacon 110 and the owner 140 use an elliptic curve Diffie-Hellman key agreement protocol to exchange a key (EIK) that is shared between the beacon 110 and the owner 140, as shown at 108. The shared EIK enables the resolver 130 to resolve, based on time, the identity of the beacon 110 from the EID and to direct a message from the beacon 110 and/or the sighter 120 to the owner 140. The communication between the sighter 120 and the resolver 130 as well as the communication between the resolver 130 and the owner 140 are secured using Transport Layer Security (TLS). However, any communication between the beacon 110 and/or the sighter 120 and the owner 140 is visible to the resolver 130. Adding a secure (encrypted) end-to-end communication channel from the sighter 120 to the owner 140 provides secrecy for messages from the beacon 110 and/or sighter 120 to the owner 140 using the resolver 130 as a routing element that cannot access the encrypted payload of a message between the sighter 120 and the owner 140.

End-to-End Encrypted Location-Finding

In aspects, when the beacon 110 is paired with the owner 140, the beacon 110 and the owner 140 (e.g., by using an application on a smartphone) initiate a common state and agree upon a shared, 256-bit symmetric identity key (the EIK) as described above. The beacon 110 and the owner 140 also determine a frequency (e.g., a rotation period) for rotating the value of the end-to-end encrypted ephemeral identifier (E2EE-EID) that the beacon 110 includes in the broadcast packets transmitted by the beacon 110. The beacon 110 includes an internal clock. For example, the beacon 110 can maintain an internal clock that is incremented at one second intervals. From these parameters (the rotation period, the identity key, and the current time from the clock), the beacon 110 and the owner 140 (or any device possessing these three parameters) can define a pseudorandom number generator, the output of which is predictable to whoever is in possession of these parameters.

The end-to-end encrypted location-finding protocol uses this pseudorandom number generator mechanism. A random number is generated by using 256-bit Advanced Encryption Standard (AES) Electronic Codebook (ECB) (AES-ECB-256) to encrypt the data structure illustrated in Table 1:

TABLE 1

| Byte offset | Field | Description |
|---|---|---|
| 0-10 | Padding | Value = 0xFF |
| 11 | K | Rotation period |
| | | exponent |
| 12-15 | TS[0] . . . TS[3] | Beacon time counter, |
| | | in 32-bit big-endian |
| | | format. The K lowest |
| | | bits are cleared. |
| 16-26 | Padding | Value = 0x00 |
| 27 | K | Rotation period |
| | | exponent |
| 28-31 | TS[0] . . . TS[3] | Beacon time counter, |
| | | in 32-bit big-endian |
| | | format. The K lowest |
| | | bits are cleared. |

The result of the AES-ECB-256 of the data structure is a 256-bit number denoted as r. For the following calculations, the elliptic curve domain parameters (Fₚ, n, and G) of SECP160R1 (as defined in SEC 2: Recommended Elliptic Curve Domain Parameters, Version 1.0, Sep. 20, 2000) are used for elliptic curve cryptographic (ECC) operations herein.

r′ is projected to the finite field, Fₚ, by calculating:

r=r′ mod n (1)

R, is calculated by:

R=r*G (2)

which is a point on the curve representing the public key being used. The beacon advertises Rₓ, which is the x coordinate of R, as its E2EE ephemeral identifier. Note that Rₓ is 20 bytes long to fit in a standard BLE advertisement channel PDU.

An E2EE-EID frame is encoded in the advertisement channel PDU as a Service Data block associated with the Eddystone service Universally Unique Identifier (UUID). The E2EE-EID frame layout is illustrated in Table 2:

TABLE 2

| Byte offset | Field | Description |
|---|---|---|
| 0 | Frame Type | Value = 0x40 |
| 1 | E2EE-EID[0] | 20-byte Ephemeral |
| | | Identifier that can be |
| | | used to derive an |
| | | encryption key. |
| 2 | E2EE-EID[1] | |
| . . . | . . . | |
| 20 | E2EE-EID[19] | |

End-to-End Encrypted Location-Finding Encryption

To encrypt a message, m, (e.g., the message is the reported location where the sighter 120 received an advertisement packet from the beacon 110) the sighter 120, having received Rₓ from the beacon 110, generates a random number, s, in Fₚ, as described above.

The sighter 120 computes a seed, S, from the random number and the ECC base point, G:

S=s*G (3)

The sighter 120 computes the point, R, on the curve representing the public key from the received Rₓ:

R=(Rₓ,R_{y}) (4)

by the substitution in the curve equation and picking an arbitrary R_{y} value out of the possible results.

The sighter 120 computes a public key, k:

k=HKDFSAH256((s*R)ₓ) (5)

where (s*R)ₓ is the x coordinate of the curve multiplication result.

URₓ and LRₓ are the upper (most significant) and lower (least significant) 80-bits of Rₓ, respectively (in big-endian format). Similarly, USₓ and LSₓ are the upper and lower 80-bits of S, respectively (in big-endian format).

The sighter 120 computes a nonce where:

nonce=LRₓ∥LSₓ (6)

The sighter 120 computes (m′, tag), where:

(m′,tag)=AESEAX256ENC(k,nonce,m) (7)

The sighter 120 sends a message to the owner 140 that includes URₓ, Sₓ, m′, and tag in the message. The message may be forwarded via an untrusted node, such as the resolver 130.

End-to-End Encrypted Location-Finding Decryption

The owner device 140, which is in possession of the identity key and the rotation period exponent, receives the message from the sighter 120 and decrypts the message. The owner 140 having received URₓ, obtains the beacon time counter value on which URₓ, is based and computes the anticipated value of r as defined above.

The owner 140 computes:

R=r*G (8)

and verifies a match to the value of URₓ, provided in the message received from the sighter 120.

The owner 140 computes the seed, S:

S=ₓ,S_{y}) (9)

by substitution in the curve equation and picking an arbitrary S_{y} value out of the possible results.

The owner 140 computes the public key, k:

k=HKDFSHA256((r*S)ₓ) (10)

where (r*S)ₓ is the x coordinate of the curve multiplication result.

The owner 140 computes the nonce:

nonce=LRₓ∥LSₓ (11)

The owner 140 computes the decrypted value of the message, m:

m=AESEAX256DEC(k,nonce,m′,tag) (12)

Location-Finding System

When a user procures a beacon device that supports end-to-end encrypted location-finding (e.g., a standalone beacon device, a device including a beacon, a Bluetooth device that supports beacon transmissions in addition to supporting other Bluetooth profiles, or the like), the user provisions the beacon device to configure end-to-end encrypted location-finding. For example, the user initiates provisioning using an application on a user device (e.g., a smartphone or a computing device) by setting the identity key and rotation period as described above. The identity key is shared between the beacon device (the beacon 110) and the user device (the owner 140) but kept secret from other devices in the system, such as the sighter 120 and the resolver 130. While the resolver 130 (e.g., a cloud-based resolver service) does not know the identity key, the resolver 130 is made aware of the existence of the beacon 110 and the associated owner 140. For example, the provisioning application provides the associated identities of the beacon 110 and the owner 140 to the resolver 130 that in turn stores those identities in any suitable manner for later use to resolve the identity of the owner 140 for messages received from the sighter 120. The beacon 110 is any device capable of storing the identity key, maintaining clock time, generating an E2EE-EID, and transmitting a beacon packet that includes the E2EE-EID. For example, the beacon 110 may be a fix-mounted beacon, an asset tag affixable to a moveable object, a personal tag carried by a person, wireless earbuds, a smart-watch, a camera, a mobile phone, a mobile computing device, or the like.

The owner device 140 periodically precalculates (e.g., on a daily basis) the anticipated ephemeral identifiers for that period (e.g., for the next 24 hours), as described above. The owner device 140 then truncates the precalculated ephemeral identifiers. For example, the owner device 140 truncates the precalculated ephemeral identifier to any suitable length, such as keeping the number of least significant bits that is equal to one-half of the length of the public key. In another example, the owner device 140 truncates the precalculated ephemeral identifier to keep the 80 least significant bits of the precalculated ephemeral identifier. The owner device 140 then uploads the truncated, precalculated ephemeral identifiers to the resolver 130. The resolver 130 associates the truncated, precalculated ephemeral identifiers with the previously stored associated identities of the beacon 110 and the owner 140 for later use in resolving ownership of messages received from one or more sighters 120.

The sighter 120 is any device capable of receiving and decoding a beacon packet to recover the identifier of a beacon 110, generating and encrypting a message (as described above), and communicating the message to the resolver 130. For example, the sighter device 120 includes a smartphone, a wireless local area network (WLAN) access point, a home automation hub, a security hub, an HVAC hub, an energy management hub, a smart-speaker, a thermostat, a hazard detector (e.g., for smoke and/or carbon monoxide), a network-connected camera, a lighting unit, a lighting controller, an entryway interface device, an occupancy sensor, a home-automation border router, a handheld (e.g., mobile) tag scanner, a fix-mounted tag scanner, or any other types of wireless network devices such as connected appliances and/or controlled systems, such as refrigerators, stoves and ovens, washers, dryers, air conditioners, pool heaters, irrigation systems, security systems, and so forth, as well as other electronic and computing devices, such as televisions, entertainment systems, computers, intercom systems, garage-door openers, ceiling fans, control panels, or the like.

The resolver 130 uses the partial identifier, URₓ, included as part of the message payload sent by the sighter 120, to determine that the sighting reported in the message is a sighting of a particular beacon 110. The resolver 130 associates the reported sighting with the particular beacon 110 and stores the received message and the association of the message to the particular beacon 110. Although the resolver 130 can resolve the beacon 110 associated with a received message, the resolver 130 is not capable of decrypting the message contents to determine the location of the beacon sighting. The resolver 130 may be any device (e.g., a computer server) or a collection of devices that form a cloud-based service.

Since the resolver 130 has no knowledge of the identity key, the resolver 130 cannot predict future EIDs, and without periodic updates of the truncated, precalculated ephemeral identifiers from the owner 140, the resolver 130 cannot track the beacon 110. The resolver 130 cannot spoof fake locations as the entire public key is not available to the resolver 130 and the resolver 130 cannot be used for a man-in-the-middle attack as the resolver 130 lacks access to the identity key.

The owner 140 of the beacon device 110 can then query the resolver 130 for the last known location of the beacon 110. The resolver 130 then forwards the encrypted location to the owner 140. Alternatively or additionally, the resolver 130 can forward messages as they are received or periodically in batches to the owner 140. Given the timestamp in the message, the owner 140 can deduce the anticipated private key of the beacon 110 at the time and perform the decryption algorithm, as described above.

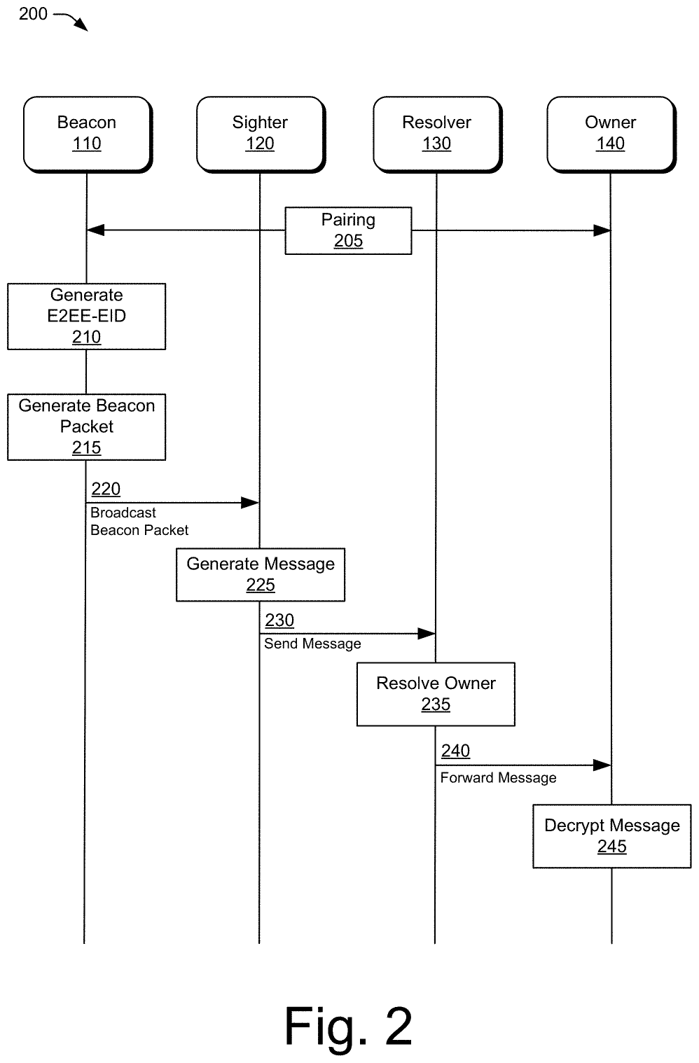

FIG. 2 illustrates data and control transactions between devices in accordance with aspects of end-to-end encrypted location-finding. Although not illustrated for the sake of illustration clarity, various acknowledgements for messages illustrated in FIG. 2 may be implemented to ensure reliable operations of end-to-end encrypted location-finding.

At 205, and as described above, the beacon 110 is paired with the owner 140 during provisioning of the beacon 110. The pairing includes sharing keys for end-to-end encrypted location-finding. At 210, the beacon generates the E2EE-EID based on the current time.

At 215, the beacon 110 generates a beacon packet. The beacon 110 includes the E2EE-EID and in the beacon packet. Note that based on a predetermined rotation rate for the E2EE-EIDs, the beacon 110 repeats the operations of 210 and 215 for each successive cycle of the rotation (not illustrated in FIG. 2). At 220, beacon 110 transmits the beacon packet. The beacon 110 may transmit the beacon packet one or more times during each cycle of the rotation.

At 225, after receiving a beacon packet from the beacon 110, the sighter 120 generates a message to send to the owner 140. Optionally, the sighter 120 may include additional data in the message, such as the sighter's location when the beacon packet was received. At 230, the sighter sends the message to the resolver 130.

At 235, the resolver 130 resolves, based on time, the identity of the beacon 110 from the E2EE-EID and compares the identity to a set of owners 140 and associated E2EE-EIDs for those owners. If the resolver identifies the owner 140 for the received message, the resolver forwards, at 240, the message to the owner 140. At 245, the owner decrypts the received message.

### Example Methods

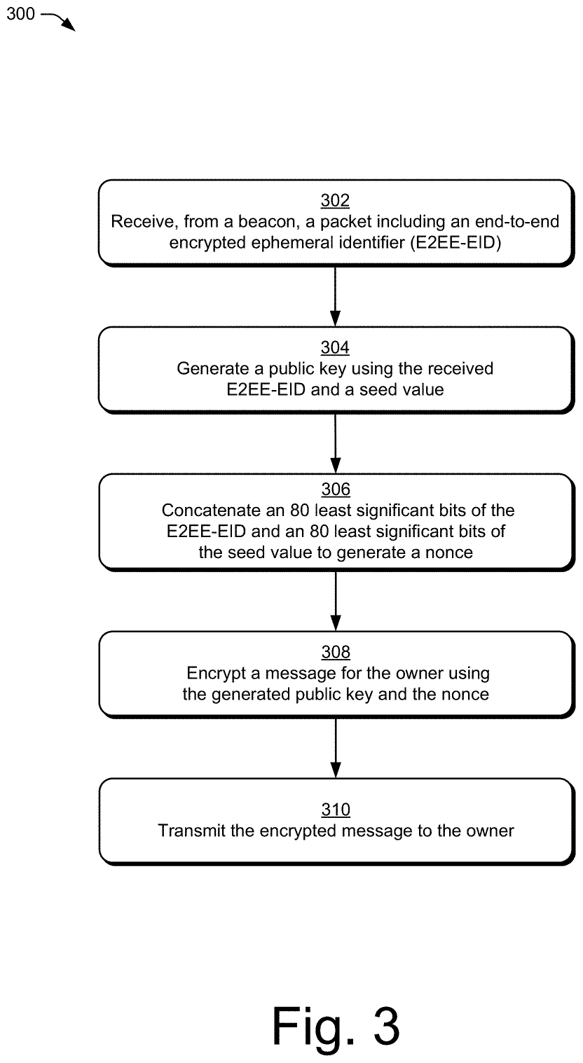

Example methods 300-500 are described with reference to respective FIGS. 3-5 in accordance with one or more embodiments of end-to-end encrypted location-finding. The order in which the method blocks are described are not intended to be construed as a limitation, and any number of the described method blocks can be skipped or combined in any order to implement a method or an alternate method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory (media) that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 of end-to-end encrypted location-finding as generally related to securely communicating a message from a sighter to an owner. At block 302, a sighter (e.g., the sighter 120) receives, from a beacon (e.g., the beacon 110), a packet including an end-to-end encrypted ephemeral identifier (E2EE-EID).

At block 304, the sighter generates a public key (e.g., the public key, k) using the received E2EE-EID and a seed value. At block 306, the sighter concatenates an 80 least significant bits of the E2EE-EID and an 80 least significant bits of the seed value to generate a nonce.

At block 308, the sighter encrypts a message for the owner using the generated public key and the nonce. At block 310, the sighter transmits the encrypted message to the owner. For example, the sighter forwards the message via a resolver 130 to the owner 140.

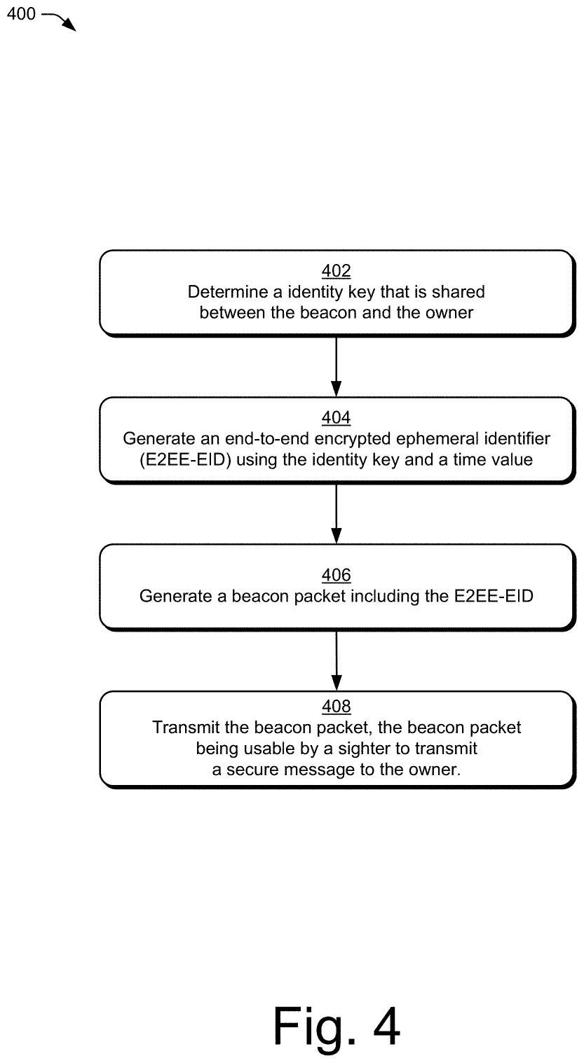

FIG. 4 illustrates example method(s) 400 of end-to-end encrypted location-finding as generally related to generating an ephemeral identifier by a beacon for securely communicating a message to an owner. At block 402, a beacon (e.g., the beacon 110) determines an identity key that is shared between the beacon and the owner. At block 404, the beacon generates an end-to-end encrypted ephemeral identifier (E2EE-EID) using the identity key and a time value.

At block 406, the beacon generates a beacon packet including the E2EE-EID. At block 408, the beacon transmits the beacon packet, the beacon packet being usable by a sighter (e.g., the sighter 120) to transmit a secure message to the owner.

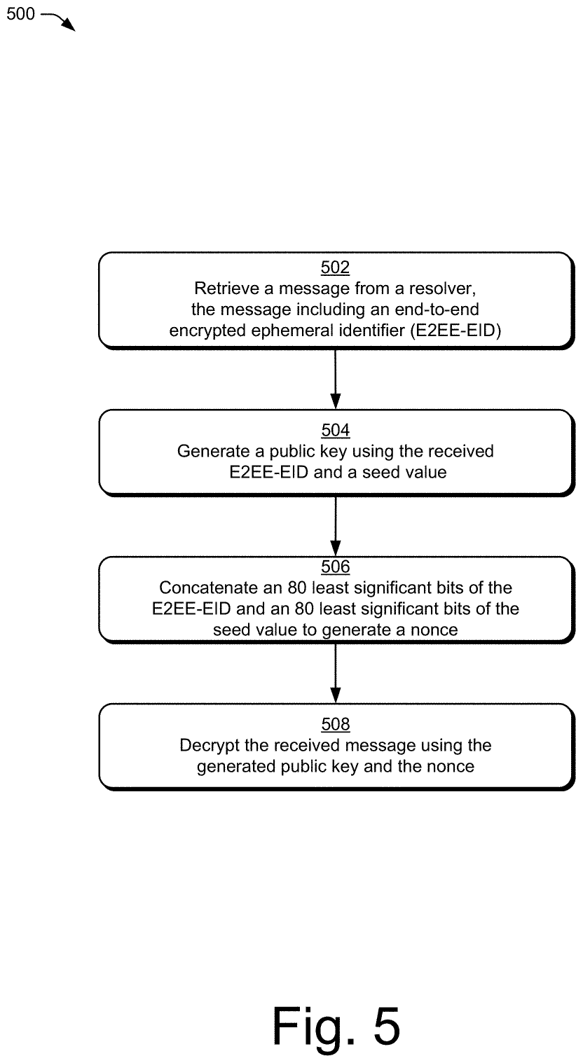

FIG. 5 illustrates example method(s) 500 of end-to-end encrypted location-finding as generally related to securely receiving a message from a sighter by an owner. At block 502, an owner (e.g., the owner 140) retrieves a message from a resolver (e.g., the resolver 130), the message including an end-to-end encrypted ephemeral identifier (E2EE-EID). At block 504, the owner generates a public key using the received E2EE-EID and a seed value.

At block 506, the owner concatenates an 80 least significant bits of the E2EE-EID and an 80 least significant bits of the seed value to generate a nonce. At block 508, the owner decrypts the received message using the generated public key and the nonce.

### Example Devices

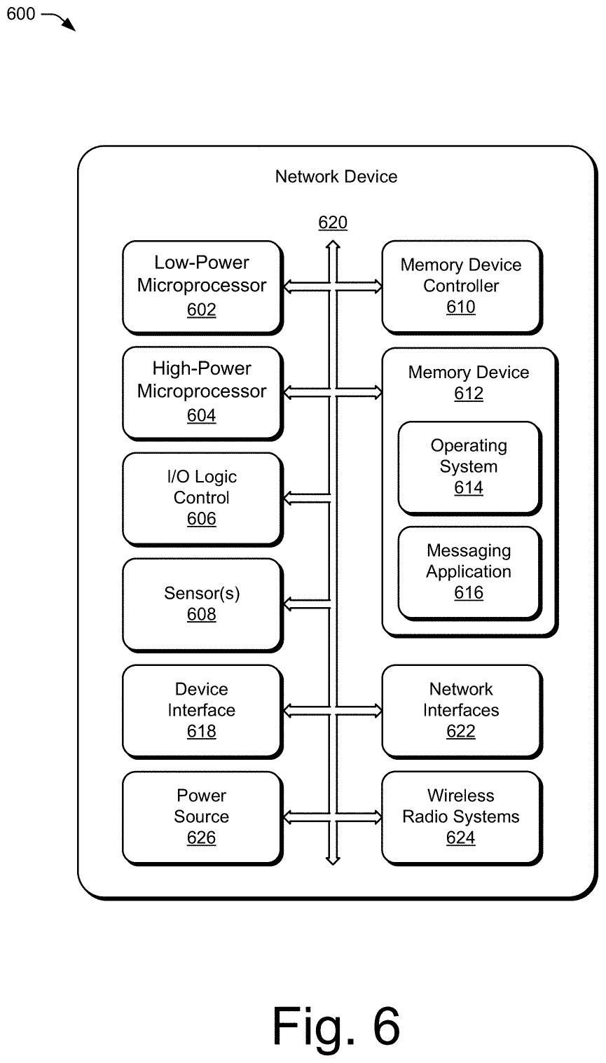

FIG. 6 illustrates an example network device 600 that can be implemented as any of the network devices in a network in accordance with one or more embodiments of end-to-end encrypted location-finding as described herein, such as the beacon 110, the sighter 120, the resolver 130, or the owner 140. The network device 600 can be integrated with electronic circuitry, microprocessors, memory, input output (I/O) logic control, communication interfaces and components, as well as other hardware, firmware, and/or software to implement the device in a network.

In this example, the network device 600 includes a low-power microprocessor 602 and/or a high-power microprocessor 604 (e.g., microcontrollers or digital signal processors) that process executable instructions. The device also includes an input-output (I/O) logic control 606 (e.g., to include electronic circuitry). The microprocessors can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits. The low-power microprocessor 602 and the high-power microprocessor 604 can also support one or more different device functionalities of the device. For example, the high-power microprocessor 604 may execute computationally intensive operations, whereas the low-power microprocessor 602 may manage less-complex processes such as detecting a hazard or temperature from one or more sensors 608. The low-power processor 602 may also wake or initialize the high-power processor 604 for computationally intensive processes.

The one or more sensors 608 may be included and implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio-frequency (RF), other electromagnetic signals or fields, or the like. As such, the sensors 608 may include any one or a combination of temperature sensors, humidity sensors, hazard-related sensors, other environmental sensors, accelerometers, microphones, optical sensors up to and including cameras (e.g., charged coupled-device or video cameras), active or passive radiation sensors, GPS receivers, and radio frequency identification detectors. In implementations, the network device 600 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or smart-operation objectives.

The network device 600 includes a memory device controller 610 and a memory device 612, such as any type of a nonvolatile memory and/or other suitable electronic data storage device. The network device 600 can also include various firmware and/or software, such as an operating system 614 that is maintained as computer executable instructions by the memory and executed by a microprocessor. The device software may also include a messaging application 616 that implements embodiments of end-to-end encrypted location-finding. The network device 600 also includes a device interface 618 to interface with another device or peripheral component and includes an integrated data bus 620 that couples the various components of the wireless network device for data communication between the components. The data bus in the wireless network device may also be implemented as any one or a combination of different bus structures and/or bus architectures.

The device interface 618 may receive input from a user and/or provide information to the user (e.g., as a user interface), and a received input can be used to determine a setting. The device interface 618 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 618 may also receive inputs from any number of peripherals, such as buttons, a keypad, a switch, a microphone, and an imager (e.g., a camera device).

The network device 600 can include network interfaces 622, such as a wireless network interface for communication with other wireless network devices in a wireless network, and an external network interface for network communication, such as via the Internet. The network device 600 also includes wireless radio systems 624 for wireless communication with other wireless network devices via the wireless network interface and for multiple, different wireless communications systems. The wireless radio systems 624 may include Wi-Fi, Bluetooth™, BLE, Mobile Broadband, and/or point-to-point IEEE 802.15.4. Each of the different radio systems can include a radio device, antenna, and chipset that is implemented for a particular wireless communications technology. The network device 600 also includes a power source 626, such as a battery and/or to connect the device to line voltage. An AC power source may also be used to charge the battery of the device.

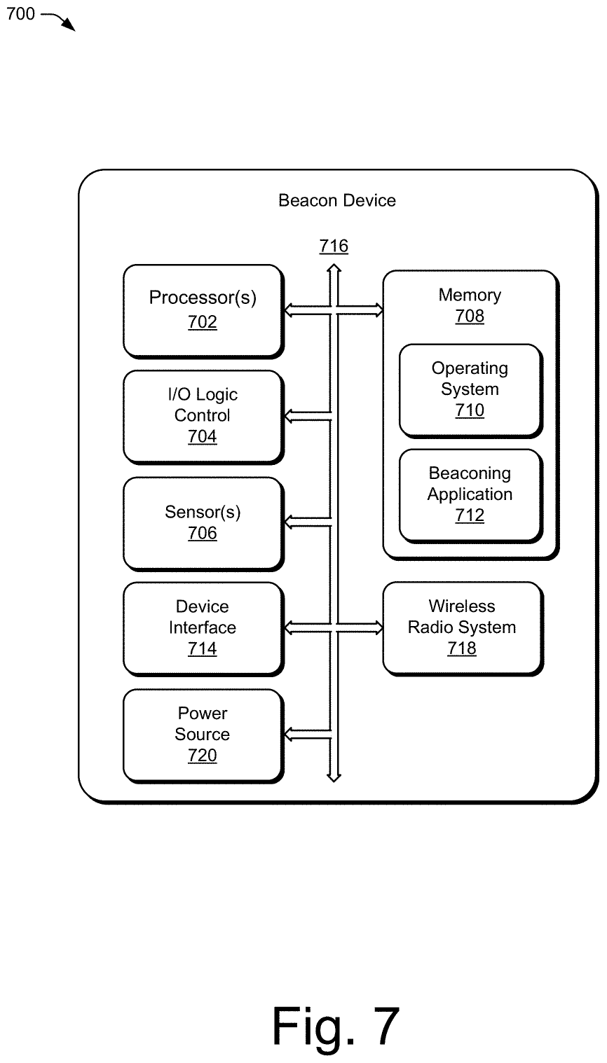

FIG. 7 illustrates an example beacon device 700 that can be implemented as the beacon device 110 in a network in accordance with one or more embodiments of end-to-end encrypted location-finding as described herein. The beacon device 700 can be integrated with electronic circuitry, microprocessors, memory, input output (I/O) logic control, communication interfaces and components, as well as other hardware, firmware, and/or software to implement the device in a network.

In this example, the beacon device 700 includes one or more processors 702 (e.g., microcontrollers or digital signal processors) that process executable instructions. The device also includes an input-output (I/O) logic control 704 (e.g., to include electronic circuitry). The processor(s) can include components of an integrated circuit, programmable logic device, a logic device formed using one or more semiconductors, and other implementations in silicon and/or hardware, such as a processor and memory system implemented as a system-on-chip (SoC). Alternatively or in addition, the device can be implemented with any one or combination of software, hardware, firmware, or fixed logic circuitry that may be implemented with processing and control circuits.

Optionally or additionally, one or more sensors 706 may be included and implemented to detect various properties such as acceleration, temperature, humidity, water, supplied power, proximity, external motion, device motion, sound signals, ultrasound signals, light signals, fire, smoke, carbon monoxide, global-positioning-satellite (GPS) signals, radio-frequency (RF), other electromagnetic signals or fields, or the like. As such, the sensors 706 may include any one or a combination of temperature sensors, humidity sensors, hazard-related sensors, other environmental sensors, accelerometers, microphones, optical sensors up to and including cameras (e.g., charged coupled-device or video cameras), active or passive radiation sensors, GPS receivers, and radio frequency identification detectors. In implementations, the beacon device 700 may include one or more primary sensors, as well as one or more secondary sensors, such as primary sensors that sense data central to the core operation of the device (e.g., sensing a temperature in a thermostat or sensing smoke in a smoke detector), while the secondary sensors may sense other types of data (e.g., motion, light or sound), which can be used for energy-efficiency objectives or smart-operation objectives.

The beacon device 700 includes a memory 708, such as any type of a nonvolatile memory and/or other suitable electronic data storage device. The beacon device 700 can also include various firmware and/or software, such as an operating system 710 that is maintained as computer executable instructions by the memory and executed by a processor. The device software may also include a beaconing application 712 that implements embodiments of an end-to-end encrypted location-finding protocol. Optionally or additionally, the beacon device 700 also includes a device interface 714 to interface with another device or peripheral component. The beacon device 700 includes an integrated data bus 716 that couples the various components of the beacon device for data communication between the components. The data bus in the beacon device may also be implemented as any one or a combination of different bus structures and/or bus architectures.

The device interface 714 may receive input from a user and/or provide information to the user (e.g., as a user interface), and a received input can be used to determine a setting. The device interface 714 may also include mechanical or virtual components that respond to a user input. For example, the user can mechanically move a sliding or rotatable component, or the motion along a touchpad may be detected, and such motions may correspond to a setting adjustment of the device. Physical and virtual movable user-interface components can allow the user to set a setting along a portion of an apparent continuum. The device interface 714 may also receive inputs from any number of peripherals, such as buttons, a keypad, a switch, a microphone, and an imager (e.g., a camera device).

The beacon device 700 can include a wireless radio system 718 for wireless communication. The wireless radio system 718 may include Wi-Fi, Bluetooth™, BLE, Mobile Broadband, and/or point-to-point IEEE 802.15.4. The wireless radio system 718 can include a radio device, antenna, and chipset that is implemented for a particular wireless communications technology. The beacon device 700 also includes a power source 720, such as a battery and/or to connect the device to line voltage. An AC power source may also be used to charge the battery of the device.

In the following text some examples are described:

Example 1: A method of securely communicating a message from a sighter to an owner, the method comprising the sighter:

receiving, from a beacon, a packet including an end-to-end encrypted ephemeral identifier (E2EE-EID);

generating a public key using the received E2EE-EID and a seed value;

concatenating an 80 least significant bits of the E2EE-EID and an 80 least significant bits of the seed value to generate a nonce;

encrypting a message for the owner using the generated public key and the nonce; and

transmitting the encrypted message to the owner.

Example 2: The method of example 1, further comprising the sighter:

generating the message for the owner.

Example 3: The method of example 2, further comprising the sighter:

including a location of the sighter in the message, the location being the location of the sighter when the sighter received the packet from the beacon.

Example 4: The method of any one of the preceding examples, wherein the encrypting the message for the owner comprises the sighter:

encrypting the message using AES-EAX-256 encryption.

Example 5: The method of any one of the preceding examples, wherein the generating a public key using the received E2EE-EID and a seed value comprises the sighter:

computing a point, R, on a curve representing the public key.

Example 6: The method of any one of the preceding examples, wherein the packet is a Bluetooth advertisement packet, and wherein the Bluetooth advertisement packet is received on a Bluetooth advertising channel.
Example 7: A method of generating an ephemeral identifier by a beacon for securely communicating a message to an owner, the method comprising the beacon:

determining an identity key that is shared between the beacon and the owner;

generating an end-to-end encrypted ephemeral identifier (E2EE-EID) using the identity key and a time value;

generating a beacon packet including the E2EE-EID; and

transmitting the beacon packet, the beacon packet being usable by a sighter to transmit a secure message to the owner.

Example 8: An electronic device comprising:

a wireless transceiver;

a processor; and

instructions that are executable by the processor to configure the electronic device to perform any one of the methods of examples 1 to 7.

Example 9: The electronic device of example 8, wherein the electronic device is a beacon, and wherein the beacon is one of: a fix-mounted beacon, an asset tag affixable to a moveable object, a personal tag carried by a person, wireless earbuds, a smart-watch, a camera, a mobile phone, or a mobile computing device.
Example 10: The electronic device of example 8, wherein the electronic device is a sighter, and wherein the sighter is one of: a smartphone, a wireless local area network (WLAN) access point, a home automation hub, a security hub, an HVAC hub, an energy management hub, a smart-speaker, a thermostat, a hazard detector, a network-connected camera, a lighting unit, a lighting controller, an entryway interface device, an occupancy sensor, a home-automation border router, a handheld tag scanner, or a fix-mounted tag scanner.
Example 11: A method of securely receiving a message from a sighter by an owner, the method comprising the owner:

retrieving the message from a resolver, the message including an end-to-end encrypted ephemeral identifier (E2EE-EID);

generating a public key using the received E2EE-EID and a seed value;

concatenating an 80 least significant bits of the E2EE-EID and an 80 least significant bits of the seed value to generate a nonce; and

decrypting the received message using the generated public key and the nonce.

Example 12: The method of example 11, wherein the message includes a location of the sighter, the location being the location of the sighter when the sighter received a packet from a beacon that generated the E2EE-EID.
Example 13: The method of example 11 or example 12, wherein the decrypting the received message comprises the owner:

decrypting the message using AES-EAX-256 decryption.

Example 14: An electronic device comprising:

a processor; and

instructions that are executable by the processor to configure the electronic device to perform any one of the methods of examples 11 to 13.

Example 15: A computer-readable storage media comprising instructions that, responsive to execution by a processor, cause a method as recited in any one of claims 1 to 7 and claims 11 to 13 to be performed.

Although embodiments of end-to-end encrypted location-finding have been described in language specific to features and/or methods, the subject of the appended claims is not necessarily limited to the specific features or methods described. Rather, the specific features and methods are disclosed as example implementations of end-to-end encrypted location-finding, and other equivalent features and methods are intended to be within the scope of the appended claims. Further, various different embodiments are described, and it is to be appreciated that each described embodiment can be implemented independently or in connection with one or more other described embodiments.

1. A method of securely communicating a message from a sighter to an owner, the method comprising the sighter:
receiving, from a beacon, a packet including an end-to-end encrypted ephemeral identifier (E2EE-EID);
generating a public key using the received E2EE-EID and a seed value;
concatenating an 80 least significant bits of the E2EE-EID and an 80 least significant bits of the seed value to generate a nonce;
encrypting a message for the owner using the generated public key and the nonce; and
transmitting the encrypted message to the owner.

2. The method of claim 1, further comprising the sighter:
generating the message for the owner.

3. The method of claim 2, further comprising the sighter:
including a location of the sighter in the message, the location being the location of the sighter when the sighter received the packet from the beacon.

4. The method of claim 1, wherein the encrypting the message for the owner comprises the sighter:
encrypting the message using AES-EAX-256 encryption.

5. The method of claim 1, wherein the generating a public key using the received E2EE-EID and a seed value comprises the sighter:
computing a point, R, on a curve representing the public key.

6. The method of claim 1, wherein the packet is a Bluetooth advertisement packet, and wherein the Bluetooth advertisement packet is received on a Bluetooth advertising channel.

7. A method of generating an ephemeral identifier by a beacon for securely communicating a message to an owner, the method comprising the beacon:
determining an identity key that is shared between the beacon and the owner;
generating an end-to-end encrypted ephemeral identifier (E2EE-EID) using the identity key and a time value;
generating a beacon packet including the E2EE-EID; and
transmitting the beacon packet, the beacon packet being usable by a sighter to transmit a secure message to the owner.

8. An electronic device configured as a sighter and comprising:
a wireless transceiver;
a processor; and
instructions that are executable by the processor to configure the electronic device to:
receive, from a beacon and using the wireless transceiver, a packet including an end-to-end encrypted ephemeral identifier (E2EE-EID);
generate a public key using the received E2EE-EID and a seed value;
concatenate an 80 least significant bits of the E2EE-EID and an 80 least significant bits of the seed value to generate a nonce;
encrypt a message for an owner using the generated public key and the nonce; and
transmit the encrypted message to the owner.

9. (canceled)

10. The electronic device of claim 8, the sighter is one of: a smartphone, a wireless local area network (WLAN) access point, a home automation hub, a security hub, an HVAC hub, an energy management hub, a smart-speaker, a thermostat, a hazard detector, a network-connected camera, a lighting unit, a lighting controller, an entryway interface device, an occupancy sensor, a home-automation border router, a handheld tag scanner, or a fix-mounted tag scanner.

11. A method of securely receiving a message from a sighter by an owner, the method comprising the owner:
retrieving the message from a resolver, the message including an end-to-end encrypted ephemeral identifier (E2EE-EID);
generating a public key using the received E2EE-EID and a seed value;
concatenating an 80 least significant bits of the E2EE-EID and an 80 least significant bits of the seed value to generate a nonce; and
decrypting the received message using the generated public key and the nonce.

12. The method of claim 11, wherein the message includes a location of the sighter, the location being the location of the sighter when the sighter received a packet from a beacon that generated the E2EE-EID.

13. The method of claim 11, wherein the decrypting the received message comprises the owner:
decrypting the message using AES-EAX-256 decryption.

14. An electronic device configured as an owner comprising:
a processor; and
instructions that are executable by the processor to configure the electronic device to:
retrieve a message from a resolver, the message including an end-to-end encrypted ephemeral identifier (E2EE-EID) the message having been securely received from a sighter by an owner;
generate a public key using the received E2EE-EID and a seed value;
concatenate an 80 least significant bits of the E2EE-EID and an 80 least significant bits of the seed value to generate a nonce; and
decrypt the received message using the generated public key and the nonce.

15. (canceled)

16. The electronic device of claim 8, the instructions are further executable to configure the electronic device to:
generating the message for the owner; and
include a location of the sighter in the message, the location being the location of the sighter when the sighter received the packet from the beacon.

17. The electronic device of claim 8, wherein the instructions to encrypt the message for the owner are executable to configure the electronic device to:
encrypt the message using AES-EAX-256 encryption.

18. The electronic device of claim 8, wherein the instructions to generate a public key using the received E2EE-EID and a seed value are executable to configure the electronic device to:
compute a point, R, on a curve representing the public key.

19. The electronic device of claim 8, wherein the packet is a Bluetooth advertisement packet, and wherein the Bluetooth advertisement packet is received on a Bluetooth advertising channel.

20. The electronic device of claim 14, wherein the message includes a location of the sighter, the location being the location of the sighter when the sighter received a packet from a beacon that generated the E2EE-EID.

21. The electronic device of claim 14, wherein the instructions to decrypt the received message are executable to configure the electronic device to:
decrypt the message using AES-EAX-256 decryption.

22. An electronic device configured as a beacon and comprising:
a wireless transceiver;
a processor; and
instructions that are executable by the processor to configure the electronic device to:
determine an identity key that is shared between the beacon and an owner;
generate an end-to-end encrypted ephemeral identifier (E2EE-EID) using the identity key and a time value;
generate a beacon packet including the E2EE-EID; and
transmit the beacon packet, the beacon packet being usable by a sighter to transmit a secure message to the owner.

23. The electronic device of claim 22, wherein the beacon is one of: a fix-mounted beacon, an asset tag affixable to a moveable object, a personal tag carried by a person, wireless earbuds, a smart-watch, a camera, a mobile phone, or a mobile computing device.
